(19) United States
(12) Patent Application Publication
(10) Pub. No.: US 2005/0077106 A1
(43) Pub. Date: Apr. 14, 2005

(54) Swing ladder

(75) Inventor: Helmut Grundler, Hollywood, FL (US)

Correspondence Address: LERNER AND GREENBERG, PA, P O BOX 2480, HOLLYWOOD, FL, 33022-2480, US

(73) Assignee: A1A Dock Products, Inc.

(21) Appl. No.: 10/949,914

(22) Filed: Sep. 24, 2004

Related U.S. Application Data
(60) Provisional application No. 60/604,509, filed on Aug. 26, 2004.

(51) Int. Cl. E06C 9/00

(52) U.S. Cl. 182/97

(57) ABSTRACT

A swing ladder has a mounting bracket and a ladder body pivotally connected to the mounting bracket. The bracket has a pinhole formed therein and a release pin secured thereto. The ladder body includes a long section with steps, a short section parallel to the long section, and a curved section connecting the short section and the long section. The short section of the ladder body has two pinholes formed therein on each side of the connecting device. The release pin is inserted into the pinhole in the bracket and one of the two pinholes in the short section of the ladder body for locking the ladder body in a down position or an up position.

### CROSS-REFERENCE TO RELATED APPLICATION

This application claims the benefit under 35 U.S.C. § 119 (e) of U.S. Provisional Patent Application Ser. No. 60/604,509, filed Aug. 26, 2004.

### BACKGROUND OF THE INVENTION

Field of the Invention

The invention lies in the field of ladders, especially marine ladders used on swim floats, docks, seawalls, etc. The invention relates to a swing ladder that can swing between a down position in the water and an up position out of the water. More specifically, the invention relates to a swing ladder that can be secured in both the down position and the up position by a quick release pin.

Swing ladders for marine application exist in the art. However, the existing swing ladders can only be secured in an up storage position by a pin. When the ladder is in the down position, namely in the water, the ladder sways due to a wake created by a boat or the wind, for example. The swaying of the ladder can cause injury to a person swimming toward the ladder or to a person climbing the ladder. When mooring a boat, the swaying of the ladder can also damage the boat. In addition, when the ladder is mounted on a dock in a boat wake zone, the ladder may also flop back and forth, thus causing damage to the dock.

Therefore, there is a need for an improved swing ladder that can be secured in both a down position and an up position in order to prevent injuries to persons or damage to boats or docks.

### SUMMARY OF THE INVENTION

It is accordingly an object of the invention to provide an improved swing ladder to be secured in both a down position and an up position, which overcomes the hereinafore-mentioned disadvantages of the existing swing ladders.

With the foregoing and other objects in view, there is provided, in accordance with the invention, a swing ladder including a mounting bracket with a first pinhole formed therein, a release pin, a ladder body including a long section with steps, a short section parallel to the long section, and a curved section connecting the short section and the long section, the ladder body being pivotally connected to the mounting bracket at a connecting point in the short section for movement between a down position and an up position, short section of the ladder body having second and third pinholes formed therein, the first pinhole in the mounting bracket being aligned with a respective one of the second and third pinholes in the short section of the ladder body in each of the respective down and up positions of the ladder body, and the release pin sized to be inserted into the first pinhole in the bracket and into one of the second and third pinholes in the short section of the ladder body for locking the ladder body in a respective one of the down position and the up position.

In accordance with another feature of the invention, the swing ladder further includes a connecting device for pivotally connecting the ladder body to the bracket at the connecting point.

In accordance with a further feature of the invention, the connecting device includes a through bolt, a nylon bushing, and a bearing.

In accordance with an added feature of the invention, the bushing is self-lubricating.

In accordance with an additional feature of the invention, the swing ladder further includes a securing cable securing the release pin to the bracket.

In accordance with yet another feature of the invention, the second and third pinholes are disposed on opposite sides of the connecting point.

In accordance with yet a further feature of the invention, the short section has a longitudinal axis and the second pinhole and the third pinhole are aligned with one another along a line parallel with the longitudinal axis.

With the objects of the invention in view, there is also provided a swing ladder including a mounting bracket with a first pinhole formed therein, a release pin, a ladder body pivotally connected to the mounting bracket at a connecting point for movement between a down position and an up position; the ladder body having second and third pinholes formed therein on each side of the connecting point, the first pinhole in the mounting bracket being aligned with a respective one of the second and third pinholes in each of the respective down and up positions of the ladder body, and the release pin sized to be inserted into the first pinhole in the bracket and into one of the second and third pinholes in the ladder body for locking the ladder body in a respective one of the down position and the up position.

With the objects of the invention in view, there is further provided a swing ladder, including a ladder body and a device for selectively locking the ladder body in up and down positions.

In accordance with a concomitant feature of the invention, the locking device includes a mounting bracket and a pin for locking the mounting bracket to the ladder body selectively in the up and down positions.

With the objects of the invention in view, there is further provided a swing ladder including a mounting bracket having a first locking point and a ladder connection point, a ladder body pivotally connected to the mounting bracket at the ladder connection point for movement of the ladder body between a down position and an up position, a locking device for locking the ladder body in the down position and the up position, the ladder body having second and third locking points adjacent the connecting point, the locking device locking the ladder body in the down position at the second locking point and the first locking point, and the locking device locking the ladder body in the up position at the third locking point and the first locking point.

Other features that are considered as characteristic for the invention are set forth in the appended claims.

Although the invention is illustrated and described herein as embodied in a swing ladder, it is, nevertheless, not intended to be limited to the details shown because various modifications and structural changes may be made therein without departing from the spirit of the invention and within the scope and range of equivalents of the claims.

Additional advantages of the invention will be set forth in part in the description which follows, and in part will be clear from the description, or may be learned by practice of the invention. The advantages of the invention will be realized and attained by the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a fragmentary perspective view of a swing ladder according to the invention in a down position;

FIG. 2A is a fragmentary side elevational and partially hidden view of the swing ladder of FIG. 1;

FIG. 2B is fragmentary side elevational and partially hidden view of the swing ladder of FIG. 2A with the ladder body in a transition from the down position to the up position;

FIG. 2C is a fragmentary side elevational and partially hidden view of the swing ladder of FIG. 2B with the ladder body in an up position; and

FIG. 3 is a fragmentary cross-sectional and partially hidden view along section line III-III in FIG. 2A.

### DETAILED DESCRIPTION OF THE PREFERRED EMBODIMENTS

The invention may be understood more readily by reference to the following detailed description of preferred embodiments of the invention.

Before the invention is disclosed and described, it is to be understood that the terminology used herein is for the purpose of describing particular embodiments only and is not intended to be limiting. It must be noted that, as used in the specification and the appended claims, the singular forms “a,” “an” and “the” include plural referents unless the context clearly dictates otherwise.

The invention will now be described in detail with reference to the accompanying drawings.

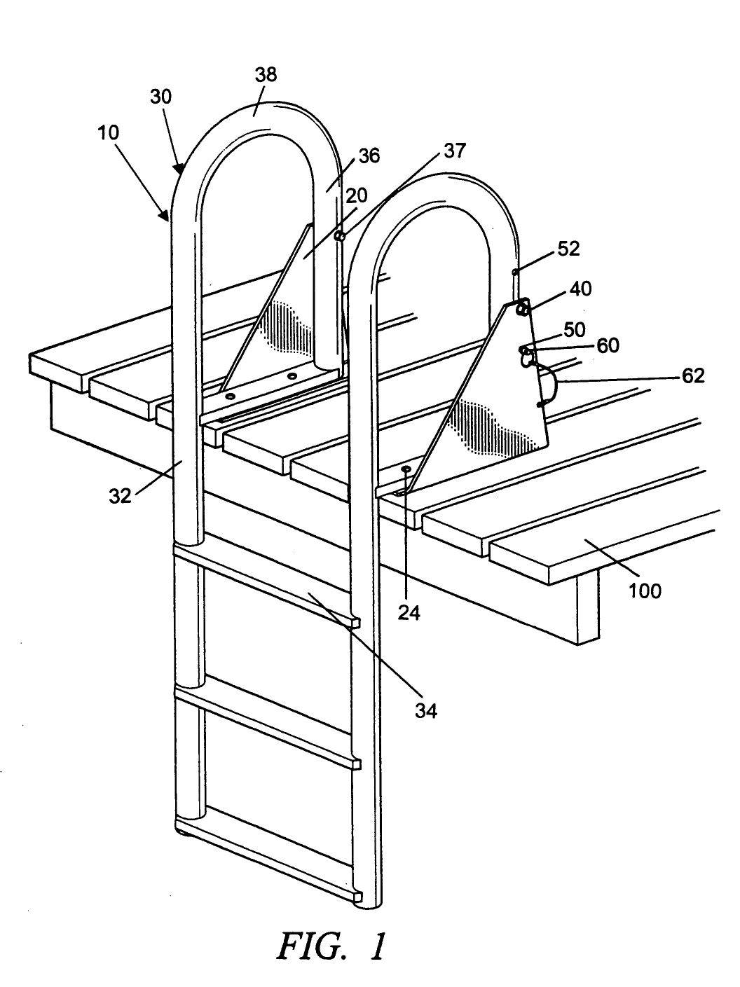

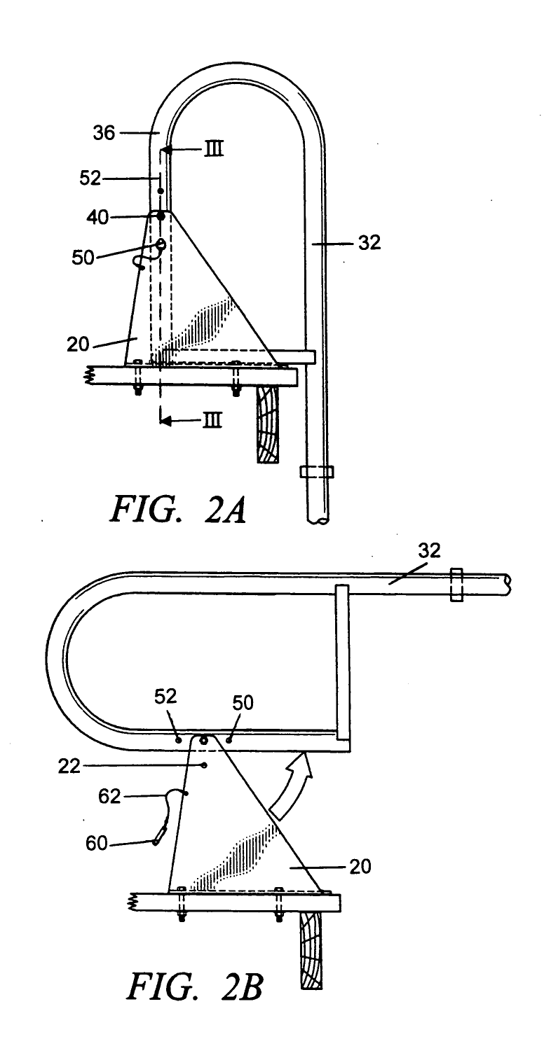

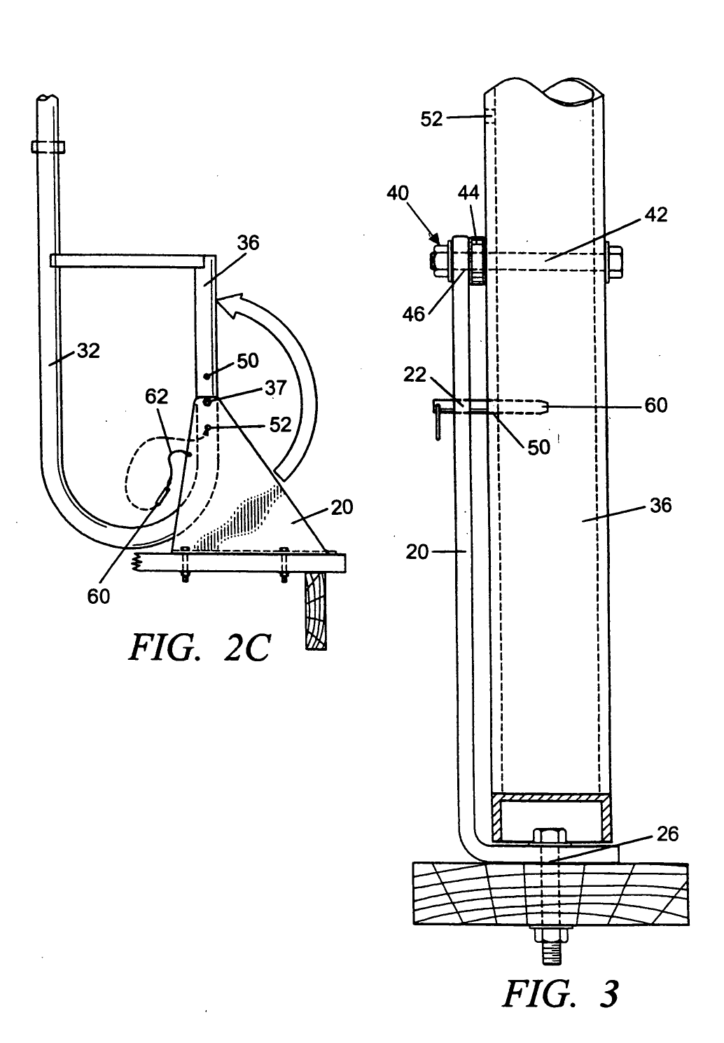

Referring now to the figures of the drawings in detail and first, particularly to FIG. 1 thereof, there is shown a swing ladder 10 according to the invention having a mounting bracket 20 mounted on a dock 100 by mounting bolts 26 (see FIG. 3) through mounting bolt holes 24 formed in the bracket 20. The ladder 10 also has a ladder body 30 pivotally connected to the mounting bracket 20 by a connecting device 40 including a through bolt 42, a nylon bushing 44, and a bearing 46 (see FIG. 3). The ladder body 30 has a long section 32 with several steps 34 and a short section 36 parallel to the long section 32 and connected to the long section 32 through a curved section 38. The ladder body 30 is pivotally connected to the mounting bracket 20 at a connecting point 37 in the short section 36 of the ladder body 30. A pinhole 50, 52 is provided on each side of the connecting point 37 in the short section 36 for accommodating a quick release pin 60 (see more clearly in FIGS. 2B, 2C and 3) secured to the bracket 20 by a securing cable 62. The bracket 20 has a pinhole 22, which matches the diameter and location of the pinholes 50, 52 in the short section 36 of the ladder body 30 in a down position and an up position, respectively.

The features including the mounting bracket 20, the pinhole 22 in the bracket 20, the connecting device 40, 42, 44, 46, the pinholes 50, 52 in the short section 36 of the ladder body 30, and the quick release pin 60 collectively can be referred to as a locking device.

FIGS. 2A-2C are partial side views of the swing ladder, showing the course of the swing ladder 10 swinging from a down position (FIG. 2A) through a transition position (FIG. 2B) to an up position (FIG. 2C). In the down position as shown in FIG. 2A, the pinhole 22 in the bracket 20 matches with the pinhole 50 in the short section 36 of the ladder body 30. The ladder can be secured in the down position by inserting the quick release pin 60 through the pinholes 22 and 50. In the up position as shown in FIG. 2C, the pinhole 22 in the bracket 20 matches with the pinhole 52 in the short section 36 of the ladder body 30. The ladder can be secured in the up position by inserting the quick release pin 60 through the pinholes 22 and 52.

FIG. 3 is a partial cross-sectional view taken along line III-III in FIG. 2A. FIG. 3 shows that the bracket 20 is connected to the short section 36 of the ladder body 30 by the through bolt 42, the nylon bushing 44, and the bearing 46 at the connecting point 37. The bushing 44 is self-lubricating. The quick release pin 60 is inserted into the pinholes 22 and 50, respectively, located in the bracket 20 and the short section 36 of the ladder body 30, and locks the ladder body 30 in the down position.

It is clear from the above description that the swing ladder according to the invention has the advantage that the ladder body can be secured both in a down position and in an up position. The ladder can be locked and stored in the up position out of the water to eliminate marine growth, prevent ladder intrusion during boat mooring, and prevent any damage to person or boat because it cannot be blown or tipped over by wind or by accident. The ladder can also be locked in the down position in the water to eliminate swaying of the ladder by a wake from a boat (which can cause injury to someone swimming towards the ladder or climbing the ladder), to prevent injury to a person or damage to a boat caused by the ladder being pulled away from the dock by someone during boat mooring, and to prevent damage to the dock caused by the ladder flopping back and forth when the ladder is mounted on the dock in a boat wake zone, for example.

Other embodiments of the invention will be apparent to those skilled in the art from consideration of the specification and practice of the invention disclosed herein. It is intended that the specification and examples be considered as exemplary only.

1. A swing ladder, comprising:
a mounting bracket with a first pinhole formed therein;
a release pin;
a ladder body including a long section with steps, a short section parallel to said long section, and a curved section connecting said short section and said long section, said ladder body being pivotally connected to said mounting bracket at a connecting point in said short section for movement between a down position and an up position;
said short section of said ladder body having second and third pinholes formed therein, said first pinhole in said mounting bracket being aligned with a respective one of said second and third pinholes in said short section of said ladder body in each of said respective down and up positions of said ladder body; and
said release pin sized to be inserted into said first pinhole in said bracket and into one of said second and third pinholes in said short section of said ladder body for locking said ladder body in a respective one of said down position and said up position.

2. The swing ladder according to claim 1, further comprising a connecting device for pivotally connecting said ladder body to said bracket at said connecting point.

3. The swing ladder according to claim 2, wherein said connecting device includes a through bolt, a nylon bushing, and a bearing.

4. The swing ladder according to claim 3, wherein said bushing is self-lubricating.

5. The swing ladder according to claim 1, further comprising a securing cable securing said release pin to said bracket.

6. The swing ladder according to claim 1, wherein said second and third pinholes are disposed on opposite sides of said connecting point.

7. The swing ladder according to claim 1, wherein said short section has a longitudinal axis and said second pinhole and said third pinhole are aligned with one another along a line parallel with said longitudinal axis.

8. A swing ladder, comprising:
a mounting bracket with a first pinhole formed therein;
a release pin;
a ladder body pivotally connected to said mounting bracket at a connecting point for movement between a down position and an up position;
said ladder body having second and third pinholes formed therein on each side of said connecting point, said first pinhole in said mounting bracket being aligned with a respective one of said second and third pinholes in each of said respective down and up positions of said ladder body; and
said release pin sized to be inserted into said first pinhole in said bracket and into one of said second and third pinholes in said ladder body for locking said ladder body in a respective one of said down position and said up position.

9. A swing ladder, comprising:
a ladder body and a device for selectively locking said ladder body in up and down positions.

10. The swing ladder according to claim 9, wherein said locking device includes a mounting bracket and a pin for locking said mounting bracket to said ladder body selectively in said up and down positions.

11. A swing ladder, comprising:
a mounting bracket having a first locking point and a ladder connection point;
a ladder body pivotally connected to said mounting bracket at said ladder connection point for movement of said ladder body between a down position and an up position;
a locking device for locking said ladder body in said down position and said up position;
said ladder body having second and third locking points adjacent said connecting point;
said locking device locking said ladder body in said down position at said second locking point and said first locking point; and
said locking device locking said ladder body in said up position at said third locking point and said first locking point.
